(19) United States
(12) Patent Application Publication
(10) Pub. No.: US 2007/0241542 A1
(43) Pub. Date: Oct. 18, 2007

(54) Air Bag Deployment Ramp

(76) Inventor: Mark WALLACE, Ferndale, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/379,148

(22) Filed: Apr. 18, 2006

(51) Int. Cl. B60R 21/213

(52) U.S. Cl. 280/730.2; 280/728.3; 280/728.2

(57) ABSTRACT

A ramp for directing the deployment of an expanding air bag may be formed to extend from a surface of a trim panel. The ramp may comprise one or more projections having a hinge or fold line. After molding of the trim panel, the projection may be folded along the hinge line towards the surface of the panel to form a ramp structure to promote the emergence, direction and/or placement of an expanding air bag. The ramp structure may be formed on any surface of trim panels lying adjacent or over an air bag system.

### FIELD OF THE INVENTION

The present invention relates to inflatable air bags used in vehicles to protect occupants in the event of a crash, and more particularly, to a ramp that may be used to direct the path of a deploying air bag.

### BACKGROUND OF THE INVENTION

Currently, a number of inflatable air bag systems are provided in motor vehicles to cushion the occupant in the event of a crash. These air bags may typically deploy from behind molded trim panels in the steering wheel, instrument panel, seat, door panel, side trim or headliner areas of the vehicle. The air bags may be designed to inflate based on sensors which detect a sudden deceleration or change in direction of the vehicle and cushion the occupants from directly impacting hard surfaces, thus preventing injury or even death.

The air bag system typically may include one or more sensors, an inflator, an inflatable air bag and a trim panel which may hide the bag from view and aesthetically blend into the interior theme of the vehicle. The air bag may typically be made of fabric, often nylon, which may be folded or rolled up to fit behind a trim panel or covering surface until inflated. When sensors in the vehicle detect a sudden deceleration of sufficient severity, an electrical signal may be sent to the inflator. The inflator then may produce a gas for inflating the air bag into the occupant compartment. The inflated air bag may then cushion the occupant as it deflates.

Air bags were first used in the hubs of steering wheels or in the passenger side of the instrument panel of vehicles to provide occupant safety in frontal collisions. More recently, air bag systems have been developed for side impact to prevent occupant injury from off-angle, or side, impact and even for rollover events. These air bag systems are commonly referred to as side curtain air bags (or SABIC'S) and may be designed to deploy between a vehicle occupant and the side structure of the vehicle and cover the windows, doors and lateral surfaces of the vehicle when inflated.

Side curtain air bags may be mounted in a housing behind a trim panel to maintain the pleasing theme and decor of the interior of the vehicle. A side curtain air bag is typically rolled or folded into a compact, elongated shape that may be secured along the roof rail. This may involve mounting the air bag along an edge of the roof behind the headliner, behind A, B, C or D pillar trim and other panels in the vehicle. Care must be taken in the design of the air bag system and its outer trim to ensure that upon deployment the bag does not become caught on an edge of the overlying or adjacent trim panels.

For side air bags that may extend the full length of the side of the occupant compartment, tensioning or guiding means in the form of one or more tethers or straps, or sail panels (a triangular piece of fabric), may extend from the bag to one or more of the columns of the vehicle to aid in shaping the inflated bag.

As an air bag deploys, it may first expand into open spaces behind the trim panel and then deflect portions of the overlying and adjacent trim panels such that it may move into the occupant compartment and fully expand. Any unplanned resistance applied to the inflating bag by the overlying panels may affect the speed and direction of inflation.

If the bag should become caught on a trim panel, the bag may become ripped or the trim panel may be fractured and/or detached and launch into the occupant compartment. In addition, the strap or tether that aids in directing the air bag may become caught on an edge of an adjacent trim panel.

The backside of vehicle trim panels which may cover such side curtain air bags may include a number of ribs, bosses, doghouse constructions and fasteners which may become likely candidates to catch or misdirect the inflating air bag.

Accordingly, there remains a need for improved ramp designs for an inflating air bag which may be molded as part of the surface of a trim panel and which may also not require additional labor for installation.

### SUMMARY OF THE INVENTION

In one exemplary embodiment, the present invention relates to a ramp structure for guiding an air bag which is deployed adjacent a trim panel in a vehicle. The ramp structure may include a surface and one or more projections integrally formed to extend from such surface. At least one of the one or more projections may have a fold line and the projection is capable of folding along the fold line towards the surface to form a ramp structure.

In another exemplary embodiment, the present invention relates to a deployment ramp for guiding the emergence of an inflating air bag from behind a trim panel that may be integrally formed to extend from a surface of the trim panel. This integrally formed member, which may be in the form of one or more rib-like projections or protrusions, may include a fold line to allow the projection to be folded towards the surface of the panel. The shape thus formed may act as a deployment directing ramp to facilitate the emergence, direction and/or placement of the inflating air bag as it emerges from behind the panel.

### BRIEF DESCRIPTION OF THE DRAWINGS

These and other objects, features and advantages of the present invention will become apparent to those skilled in the art upon reference to the following written description and accompanying drawings in which:

FIG. 1 is a perspective view of the rear side of pillar trim panel for a vehicle illustrating a side air bag in a rolled (undeployed) position.

FIG. 2 illustrates the air bag of FIG. 1 partially deployed.

FIG. 2A is a perspective end view of a portion of the pillar trim of FIG. 2.

FIG. 3 illustrates the air bag of FIG. 1 fully deployed.

FIG. 4 illustrates an exemplary ramp structure integrally molded into the rear surface of the pillar trim of FIG. 1, before the air bag is deployed.

FIG. 5 illustrates an exemplary ramp structure and air bag of FIG. 4 with the air bag partially deployed.

FIG. 5A is a perspective end view of a portion of the pillar trim of FIG. 5.

FIG. 6 illustrates an exemplary ramp structure and air bag of FIG. 4 with the air bag fully deployed.

FIG. 7 illustrates the pillar trim of FIG. 4 as molded, before folding to form the exemplary ramp structure.

FIG. 8 is an exploded view of the circled portion of FIG. 7.

FIGS. 9 and 9A are sectional views along lines 9-9 of FIG. 7 illustrating an exemplary ramp structure in as-molded and ready for use positions, respectively.

FIGS. 10 and 10A are perspective views of the rear side of kneeblocker panel for a vehicle illustrating another exemplary ramp structure for guiding an air bag.

FIG. 11 is a perspective view of the backside of pillar trim panel for a vehicle, illustrating an exemplary ramp structure, according to the present invention, in an as-molded condition.

FIG. 11A is a side view of the pillar trim panel of FIG. 11, illustrating the exemplary ramp structure in a folded-over condition.

FIGS. 12 and 12A are perspective views of an exemplary ramp structure, according to the present invention, formed as a separate component from a trim panel, in an as-molded and ready-for-use positions, respectively.

FIG. 13 is a perspective view of the inside of a passenger compartment in a vehicle, with the pillar trim removed, illustrating the placement of the exemplary ramp structure of FIG. 12A adjacent an undeployed air bag.

### DETAILED DESCRIPTION OF THE INVENTION

The present invention is described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly references at 10A, 10B, and so forth in subsequent embodiments. Thus, where an embodiment description uses a reference character to refer to an element, the reference character applies equally, as distinguished by alphanumeric character, to the other embodiments where the element is common.

As an initial matter, it is worth noting that many trim panels which may lie over or adjacent an air bag system in a vehicle may be molded from a plastic material. Due to the complex shapes of these panels, the removal of the molded part from its mold must be along the line of draw (direction of separation) of the tooling. The present invention therefore provides for a rib, protuberance or other extending structure of any appropriate geometry which may be molded to extend substantially normal from the surface of the panel and parallel to the angle of die draw. Once the panel has been formed, the extending structure may be folded over towards the surface of the panel along a section which may be of reduced thickness to form a ramp structure. This structure may be located adjacent the air bag and provide a surface to direct an inflating air bag along an intended path towards the interior of the vehicle. The ramp structure may then urge the inflating air bag to reduce the potential of being caught on any relatively sharp features of adjacent trim panels, or the ramp structure may reduce the possibility of tearing the panels loose such that they may become a projectile in the vehicle.

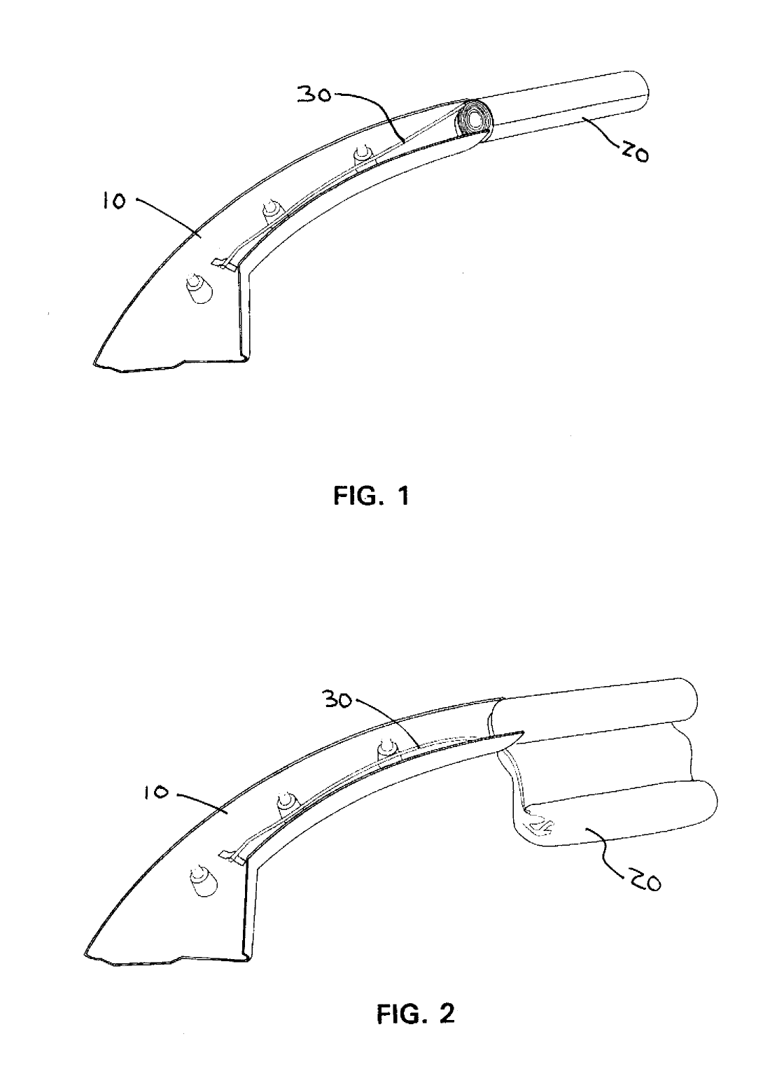

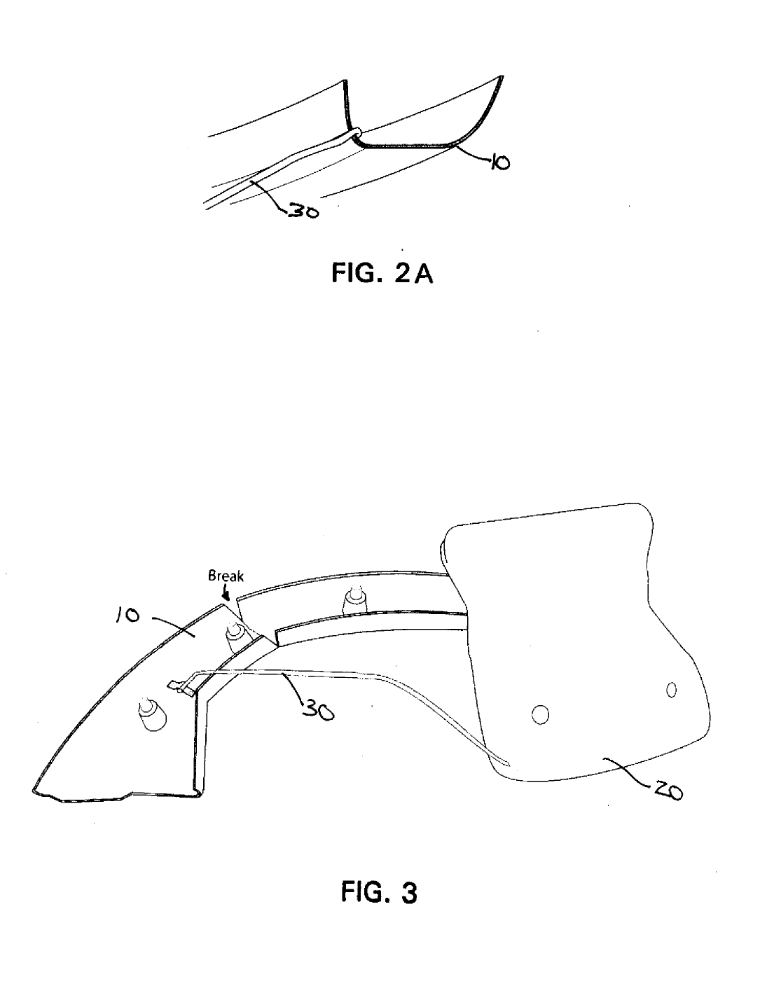

FIG. 1 is a perspective view of the rear side of an A-pillar trim panel 10 as would be installed on the driver's side of a vehicle just forward of the window in the driver's side door. The pillar trim may preferably be injection molded of a plastic such as, but not limited to, polypropylene, thermoplastic polyolefin, acrylonitrile-butadiene-styrene, nylon and blends of such with polycarbonate. Adjacent this panel and rearward in car is shown a side air bag 20 in a rolled up position ready to be deployed. In this example, the air bag when inflated will unroll (see FIGS. 2 and 3) and expand to cover at least a portion of the area between the driver's head and the driver's side window (not shown). The bag may deploy from a position along the roof rail of the vehicle where it may be hidden by trim panels and the headliner. In other situations, the side air bag or curtain may deploy from other areas along the length of the vehicle such as adjacent the B-pillar, C-pillar or D-pillar.

Also shown in FIG. 1 is a tether or guide strap 30 which may be attached at one end to a corner or edge of the air bag 20 and anchored at the other end to the pillar, pillar trim 10 or other structure. The tether or strap 30 aids in directing the expansion of the deploying air bag 20 such that the bag will cover its intended area of protection. The tether or strap 30 may be stored behind or even within the trim panel 10.

FIG. 2 is a perspective view illustrating a partially deployed air bag 20 where the tether or strap 30 has remained behind the trim panel 10. This is further illustrated in an end view in FIG. 2A. In such a situation, the tether or strap 30 may become caught or snagged behind the trim panel 10 which may result in the tether breaking or the air bag 20 being deployed in a direction which was not intended and which may not protect the vehicle occupant as planned. Another result is shown in FIG. 3, where the trim panel 10 may break under the force of the deploying air bag, potentially becoming a projectile in the passenger compartment (see area denoted “Break”).

The scenario described above may be reduced in possibility of taking place by including a ramp structure in the trim panel which may direct the strap and/or deploying air bag away from the trim panel and into its intended expanded configuration.

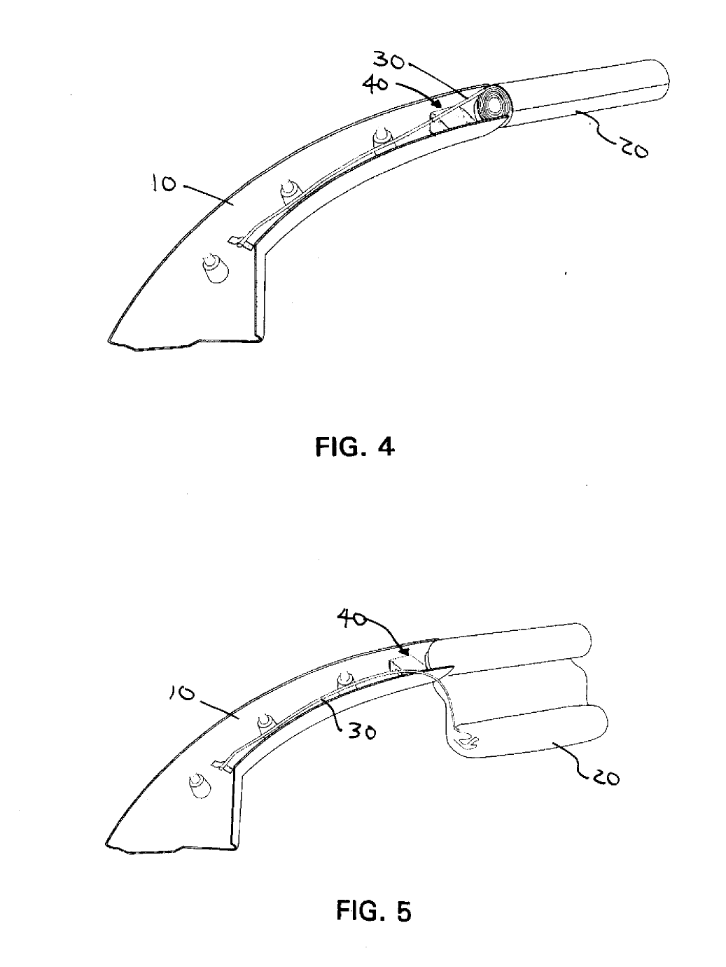

One exemplary embodiment of this ramp structure and its function is illustrated in FIGS. 4-6. A ramp structure 40 may be included integrally in the molding of the trim panel, the ramp engaging the tether 30 and/or air bag 20 as it deploys and diverting it away from an edge of the trim panel 10, or even an adjacent panel. This is shown in sequence in FIGS. 4-6. The ramp structure disclosed herein may be one or a series of platforms of various heights projecting above the surface of the trim panel, or a surface which is angled towards or away from the surface of the trim panel from which the structure emanates. In any case, the ramp structure provides an intermediate surface between the surface of the trim panel and the inflating air bag which may contact a portion of the air bag, or a guide strap thereof, to promote proper inflation of the air bag.

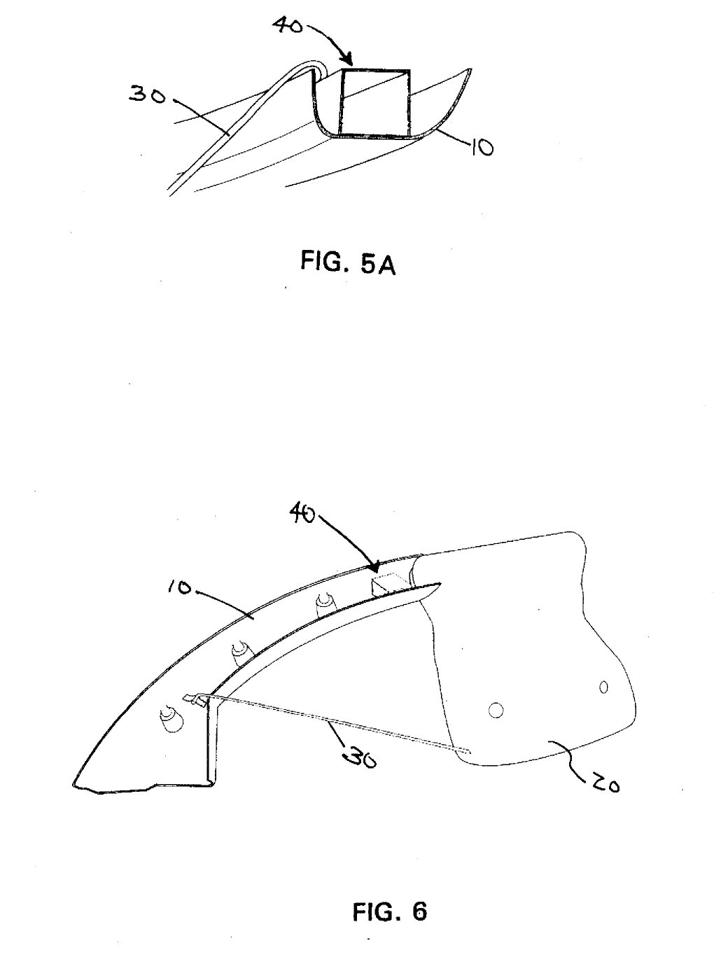

In FIG. 4 the tether 30 now may be at a position relatively closer to the edge of the trim panel 10 and less likely to get caught or snagged therein due to the presence of the ramp structure 40. As shown in FIG. 5, the bag 20 has partially expanded and the tether 30 has cleared the edge of trim panel 10 due to the presence of the ramp structure 40.

FIG. 5A is an end view of the pillar trim 10 illustrating placement of the ramp structure 40 at a position to divert the tether 30 from getting caught or snagging on the trim panel 10.

FIG. 6 illustrates a successful deployment with the bag in its intended expanded position and without trim panel breakage or misdirection of the air bag 20.

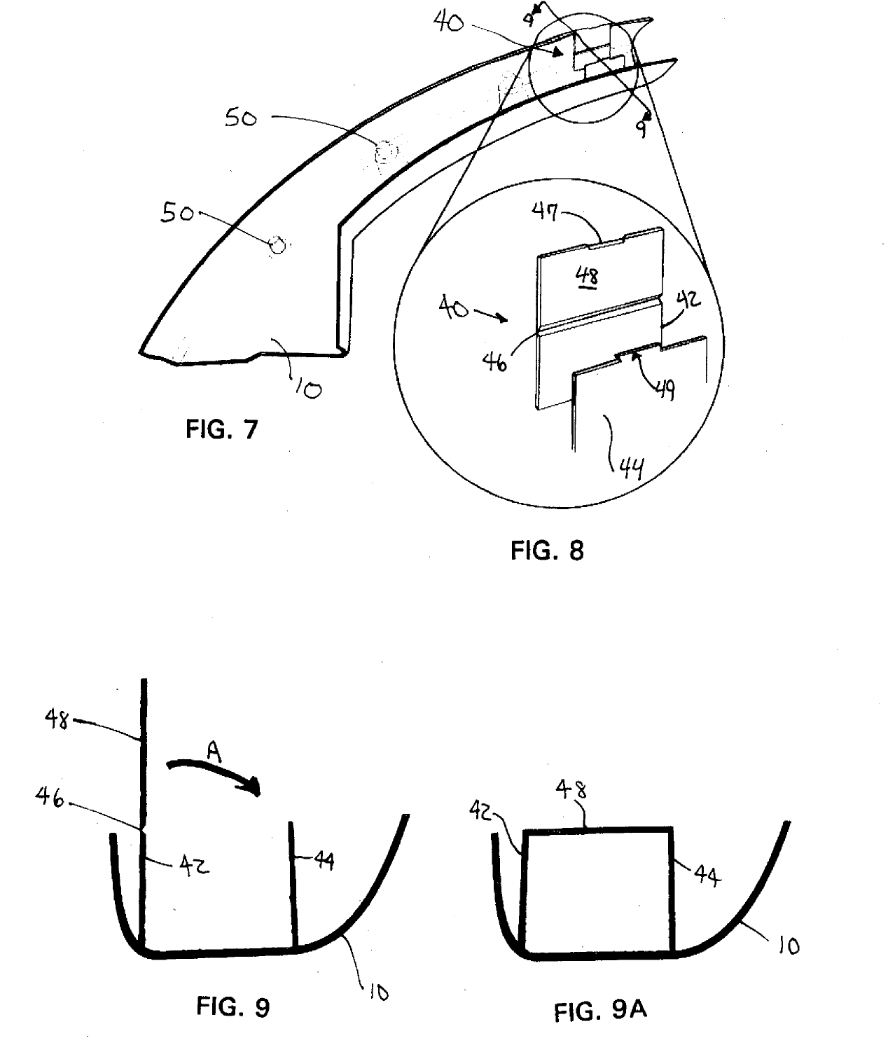

The ramp structure 40 is preferably integrally molded into the surface of the trim panel 10 to reduce costs and assembly operations. This may be achieved as shown in FIG. 7 by molding the structure 40 in a plane parallel to the angle of die draw of the panel and then folding over a section of the structure to form a ramp or step.

Molded trim panels and substrates such as described herein may be found adjacent any air bag system and are generally injection molded. Some of the panels may cover air bag systems, while others may be located adjacent air bag systems, such as in instrument panels. These panels are often moldings of complex shape having a number of bosses, ribs and projections which may strengthen the panel and provide means for attachment. To keep tooling cost and cycle times low, these ribs, bosses and projections are designed to be molded at an angle parallel to the angle of die draw (direction of separation of the tool halves). This may avoid the need for expensive slides and safeties in the tooling (mold).

In FIG. 7, three attachment bosses 50 project from the rear surface of the trim panel for attaching it in the vehicle. The ramp structure 40 may be formed by molding one or more rib-like projections 42, 44 which extend from the rear surface of the trim panel 10 parallel to the direction of die draw (that is, for instance, parallel to the angle that the bosses 50 project from the back surface of the trim panel 10). As shown in FIG. 7 and in an enlarged view in FIG. 8, projections 42 and 44 may extend from the back surface of trim panel 10. Projection 42 may include a section of thinner cross-section 46, which may act as a hinge point or foldline for an extended portion 48 of the projection. Projection 42 may also include a fastening notch 47 for attachment to projection 44. However, it should be appreciated that a foldline here may be understood to be any feature in the molded plastic that may promote folding along a particular general line or region. This may therefore include physical features such as holes, slots, etc., as well as controlling flow patterns and polymer orientation within the plastic to promote a weakening along a give region of material.

Projection 44 may be of a height different than that of projection 42 to allow the extended 20 surface 48 to be folded over and form a top surface for the ramp structure 40 which may be angled in any direction. Projection 44 may include a protuberance 49 which may be shaped to compliment fastening notch 47. While shown as rectangular, the projections 42, 44 may be of any shape (trapezoidal, rhombic, triangular, etc.) to form a top structure ramped in one or more planes. The fold line 46 may be a living hinge, or may just be an area of reduced cross-section in projection 42.

After the trim panel had been formed, the extension portion 48 of projection 42 may be folded along line 46 (see Arrow A) and protuberance 49 engaged with notch 47 to secure the extension 48 as top of the ramp structure 40. This is illustrated in sectional view in FIG. 9, as molded, and FIG. 9A, as assembled for use. It may also be appreciated that the extension portion 48 of projection 42 may be folded or hinged along line 46 and attached to projection 44, or even the back surface of trim panel 10, by sonic welding, heat staking, etc.

It is further contemplated that more than one fold line or hinge point may be included in the one or more projections emanating from the surface of a trim panel to allow the integral formation of a structure which may be hinged or folded to form a ramp for an air bag system.

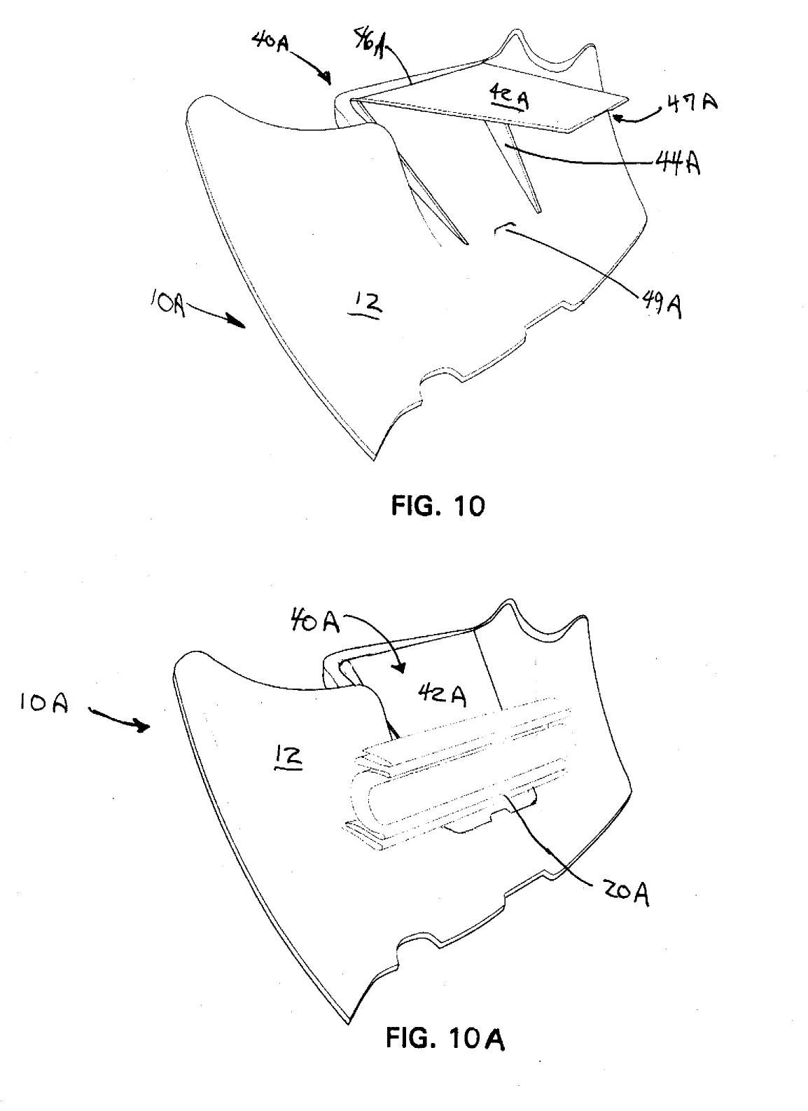

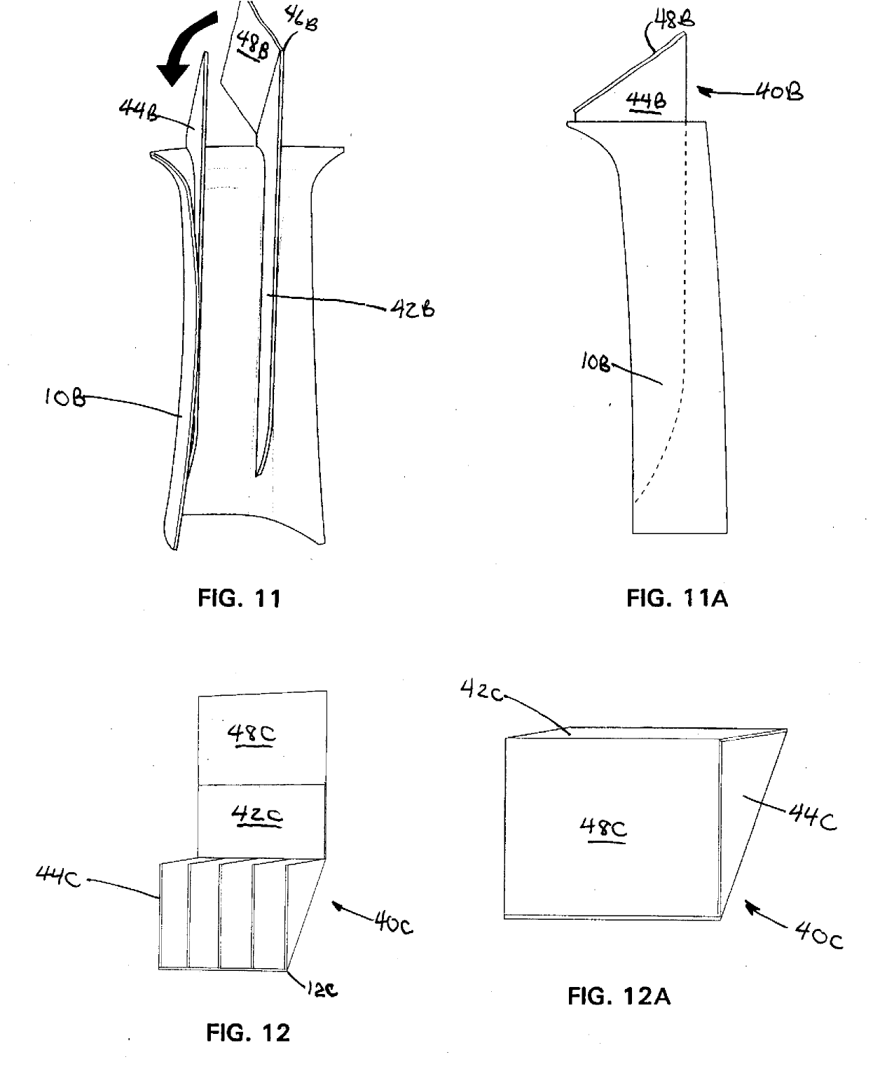

Another exemplary embodiment of a ramp structure for guiding an air bag, according to the present invention is shown in FIGS. 10 and 10A. FIG. 10 is a perspective view of trim panel 10A, which is typically referred to in the automobile industry as a kneeblocker. This panel may be used in conjunction with an air bag to engage an occupant's knees in the event of a collision. The air bag (shown in phantom as 20A in FIG. 11A), may be located forward of the kneeblocker (in car) and upon inflation move the kneeblocker towards the occupant. A ramp structure 40A may be formed in the molded plastic panel 10A by forming a projection 42A which is integrally molded parallel to the direction of die draw, D. This allows the structure to be formed in relatively simple and inexpensive tooling. Once the molded part 10A has been formed, the projection 42A may be folded along hinge line 46A and fastened to the surface 12 of the kneeblocker 10A. Fastening may be mechanical, by engaging an end of the projection 47A with a feature 49A in the surface 12 of the kneeblocker, by adhesive or by plastic welding to a surface adjacent the folded projection. When in a fastened position (FIG. 10A), the projection 42A may create a ramp structure 40A for guiding the air bag.

Another exemplary embodiment of a structure for guiding an air bag is shown in FIGS. 11 and 11A. FIG. 11 is a perspective view of the backside of a molded pillar trim 10B for a vehicle (e. g. a B-pillar trim panel) illustrating a pair of ribs 42B, 44B projecting from the back surface of the panel. One of the projecting ribs 42B may include a foldline 46B and an extension 48B, which may be molded in the angle of die draw and to assist in removal of the panel 10B from the injection mold. As shown in FIG. 11A in side view, after demolding, the extension 48B may be folded over (see bold arrow in FIG. 11) and fastened to the adjacent rib 44B, along the foldline 46B to form an angled ramp structure 40B for guiding a side air bag which may be stored above and behind the panel along the inside of the roof rail of a vehicle. This structure 40B cannot be molded integrally in the folded condition without relatively expensive slides (movable mold feature) and other tooling features due to the die angle restriction imposed by the complex shape of the panel 10B.

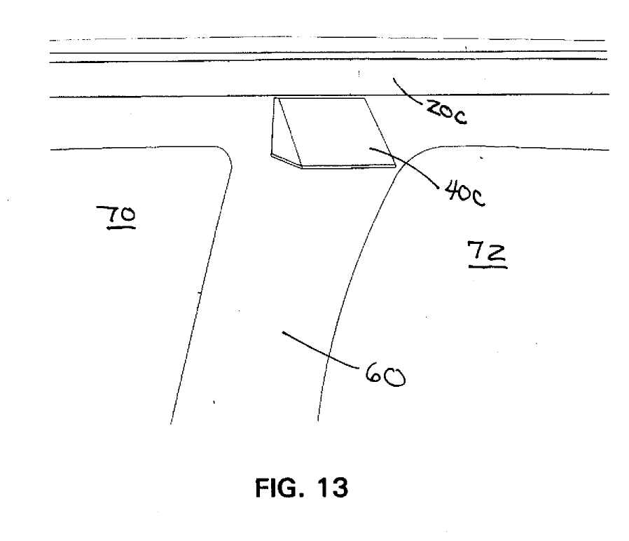

Still another exemplary embodiment for a ramp structure is shown in FIGS. 12, 12A and 13. In this embodiment, a separate ramp structure 40C may be molded comprising a plurality of projecting ribs 44C which project from a surface 12C. Another rib-like structure 42C also may project from surface 12C but in a different plane from ribs 44C. The rib-like structure 42C may further include an extension 48C and foldline 46C as shown in FIG. 12. FIG. 12A is a perspective view of the ramp structure 40C formed by folding extension 48C and rib 42C and attaching the extension to either rib 44C or surface 10C. FIG. 13 is a perspective view of the inside of a passenger compartment of a vehicle, with the pillar trim removed, illustrating the placement of the exemplary ramp structure 40C of FIG. 12A adjacent an undeployed air bag 20C. The ramp structure 40C is thus positioned for guiding the air bag 20C when it is deployed. In this view, B-pillar 60 is bounded by side windows 70, 72.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims one may practice the invention otherwise than as the description and drawings specifically show and describe.

1. A ramp structure for guiding an air bag which is deployed adjacent a trim panel having a rear surface in a vehicle, the ramp structure comprising:
one or more integrally molded rib-like projections which extend from a rear surface of the trim panel;
at least one of the one or more rib-like projections having a fold line;
wherein the at least one of said one or more rib-like projections have a fold line that is capable of being folded along said fold line towards the rear surface of the trim panel to form said ramp structure.

2. The ramp structure of claim 1 wherein said projection has a thickness and said fold line comprises an area of reduced thickness.

3. The ramp structure of claim 1 wherein said trim panel at least partially covers said air bag and upon inflation of said air bag, said air bag contacts said ramp structure.

4. The ramp structure of claim 1 wherein said air bag further includes a guide strap and upon inflation of said air bag said guide strap contacts said ramp structure.

5. The ramp structure of claim 1 wherein said one or more projections are integrally formed to extend from an inner surface of said trim panel.

6. The ramp structure of claim 1 wherein said one or more projections are integrally formed to extend from an outer surface said trim panel.

7. An air bag deployment guide for use with an air bag located adjacent a trim panel having a rear surface in a vehicle, the air bag deployment guide comprising:
a ramp structure comprising one or more projections integrally formed to extend from a rear surface of said trim panel;
at least one of said projections including a fold line;
wherein said at least one projection is folded along said fold line towards said rear surface of said trim panel to form said ramp structure;
wherein when installed in said vehicle said deployment guide is positioned to contact said air bag and guide said air bag past said trim panel.

8. The airbag deployment guide of claim 7 wherein said air bag further includes a guide strap and upon inflation of said air bag said guide strap contacts said ramp structure.

9. A method of forming a ramp structure on the surface of a trim panel, the method comprising:
forming a trim panel having an inner and outer surface;
integrally forming one or more projections which extend from one of said inner or outer surfaces, wherein at least one of said projections includes a fold line;
folding said at least one projection along said fold line towards said one of said surfaces; and
attaching said folded projection to said surface of said trim panel or to another of said projections.

10. The method of claim 9, wherein said fold line comprises an area of reduced thickness.

11. The method of claim 9 wherein said fold line is a living hinge.

12. A method of guiding the deployment of an inflating air bag, comprising the steps of:
providing an air bag capable of being inflated by gas;
providing a trim panel adjacent said air bag, said trim panel including a ramp structure for guiding at least a portion of said air bag as it inflates, said ramp structure comprising at least one integrally formed projection extending from a surface of said trim panel and folded along a fold line to form a surface for guiding said air bag; and
inflating said air bag and contacting said ramp structure with said air bag.

13. The method of claim 12, wherein said air bag further includes a guide strap and upon inflation of said air bag said guide strap contacts said ramp structure.

14. The method of claim 12, wherein said fold line comprises a region of reduced thickness.

15. A side air bag system for a vehicle, comprising:
a roof rail and one or more downward extending pillars which house at least a portion of said air bag system;
one or more trim panels attached to said roof rail and/or downward extending pillars;
an air bag at least partially housed adjacent said one or more trim panels and said roof rail and/or said one or more pillars;
a ramp structure projecting from a rear surface of said trim panel towards said roof rail or said one or more pillars, the ramp structure comprising at least one projection folded along a fold line towards said rear surface of said trim panel.

16. The side airbag system of claim 15, wherein said fold line is an area of reduced thickness.

17. A ramp structure for guiding an air bag which is deployed adjacent a trim panel in a vehicle, the ramp structure comprising:
a rear surface;
one or more projections integrally formed to extend from said rear surface;
at least one of the one or more projections having a fold line;
wherein the at least one projection having a fold line is capable of folding along said fold line towards said surface to form a ramp structure.
